(19) United States
(12) Patent Application Publication
(10) Pub. No.: US 2026/0330802 A1
(43) Pub. Date: Oct. 22, 2026

(54) n-Shadow Anti-falsing Calculation (n-SAC) for Computer Vision Systems

(71) Applicant: Curtis Rasmussen, York, PA (US)

(72) Inventor: Curtis Rasmussen, York, PA (US)

(21) Appl. No.: 19/183,732

(22) Filed: Apr. 18, 2025

(51) Int. Cl. G06V 10/60; G06T 7/13

(52) U.S. Cl. CPC G06V 10/60; G06T 7/13

(57) ABSTRACT

The present invention provides a system and method for validating detected features in sequential image data using metric-consistency analysis. Computer vision systems frequently detect edges or regions that may correspond to solid objects or deceptive visual artifacts. The disclosed validation layer acquires sequential images from a moving or stationary platform, identifies candidate features using preexisting detection techniques, computes a consistency metric for each feature across the sequence, and compares the metrics to discriminate stable features associated with solid objects from inconsistent features associated with visual artifacts. The method is platform-, equipment-, and language-agnostic and integrates with existing computer vision pipelines to reduce false positives. Representative scenes, measurement points, and consistency equations are illustrated in the drawings.

### BACKGROUND OF THE INVENTION

n-Shadow Anti-falsing Calculation (n-SAC) for Computer Vision Systems is designed to provide computer vision (CV) systems with a shadow verification system. CV systems often have issues consistently detecting object edges, misidentifying shadow edges with those of solid objects. Computer vision systems used in autonomous vehicles are susceptible to misidentification of shadows, and misidentification could result in an accident or fatality.

### SUMMARY OF THE INVENTION

n-SAC provides a mathematically calculated method of shadow verification for preexisting computer vision (CV) shadow detection methods for real-time video or static images. n-SAC is agnostic for platform, equipment, and computer language (e.g., Python). By coupling n-SAC with existing CV shadow detection methods (e.g., software), users will be confident that autonomous vehicles will not experience phantom braking or collisions due to shadow misidentification. Additionally, n-SAC can be used to confirm the detection of hard-to-identify shadows, such as those in windows, increasing the reliability of automated shape/object identification methods (e.g., software).

### BRIEF DESCRIPTION OF DRAWINGS

FIG. 1: An unmanned aerial vehicle (UAV) observing a solid cube and a shadow cast by a light source.

FIG. 2: A UAV observing a solid cube and a shadow cast by a light source with points of measurement for n-SAC.

FIG. 3: Basic n-SAC equation.

FIG. 4: n-SAC equation with unknown height/distance.

FIG. 5: A UAV observing a solid cube and a shadow cast by a light source with all points of measurement/observation for n-SAC.

### DETAILED DESCRIPTION OF THE INVENTION

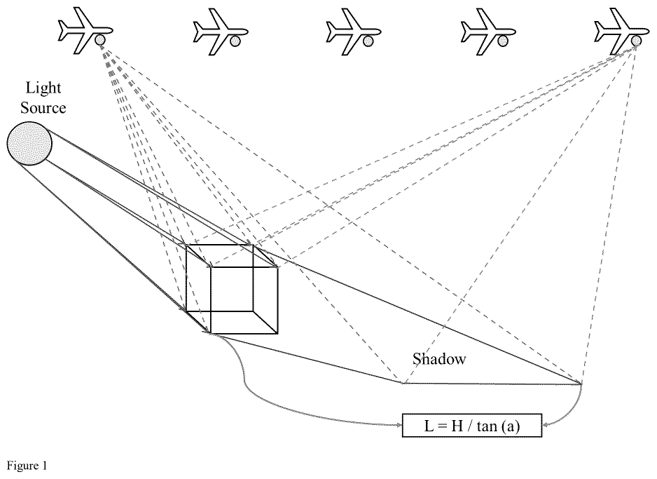

Shadows can cause computer vision (CV) algorithm issues due to edge detection/discrimination. A shadow can appear to an AI system like a solid object (FIG. 1). Depending on the focal angle, a solid object and a shadow will have different angular rates of change. The shadow focal angle primarily depends on the angle of the light source, as opposed to the focal angle (FIG. 1).

Using preexisting CV methods for edge detection, using the n-SAC equation, it becomes possible to quickly identify if an edge belongs to a solid object or a shadow. In the basic configuration, we assume a constant velocity

$$( \frac{m}{sec} ) ,$$

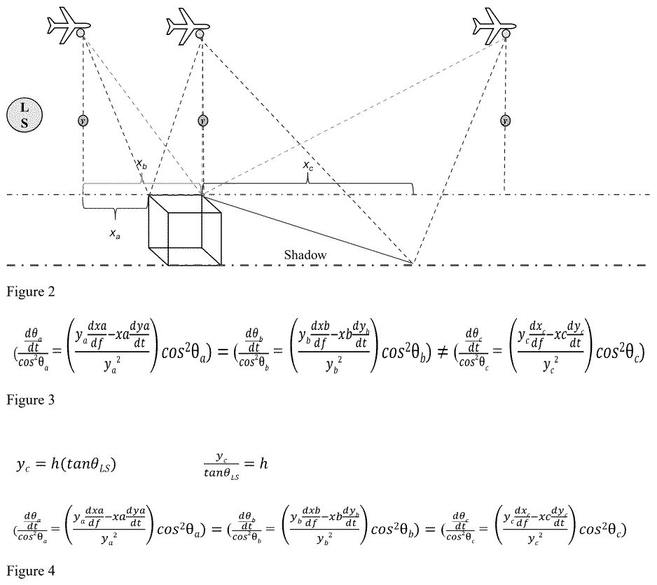

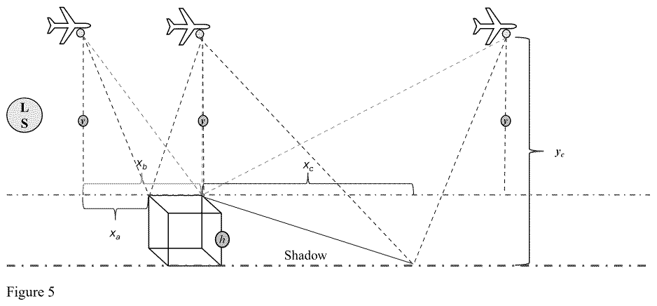

and a constant altitude/distance (y) above the object (FIG. 2). Because a shadow is projected onto a surface below the object, the angle change rate will differ due to a difference in y. For instances when all measurements/distances and speeds are known, the n-SAC equation is used (FIG. 3). By identifying the edges using CV, the equation allows for a comparison of the rate of angular change (FIG. 2). If the rates of angular change are equal, all edges belong to a solid object/non-shadow. Angular rate of change for solid objects/non-shadows will remain constant based on the velocity and altitude/distance. When an angular rate of change differs from other rates of angular change, measuring from edges, the edge with the incongruent angular rate of change comes from a shadow.

n-SAC will validate edges identified by CV methods, preventing issues such as autonomous vehicle phantom braking (when a shadow is recognized as a solid object) and generally misidentifying shadows as solid objects or solid objects as shadows.

Constant velocity and altitude/distance are not necessary for n-SAC to identify a shadow or solid object.

1. A method for validation of detected features in sequential image data using metric consistency analysis, comprising: acquiring a sequence of images from an imaging platform; identifying candidate features in the images using a computer vision detection process; computing a consistency metric for each candidate feature across the sequence of images, wherein the consistency metric includes a rate of change associated with the feature; and comparing the consistency metrics of the candidate features to discriminate features associated with solid objects from features associated with visual artifacts.

2. The method of claim 1, wherein the consistency metric comprises a rate of angular change relative to the imaging platform.

3. The method of claim 1, further comprising integrating the validation with a preexisting computer vision edge or region detection module.

4. The method of claim 1, wherein the sequence of images is acquired from a continuous video feed or as discrete frames.

5. The method of claim 1, wherein the imaging platform moves with substantially constant velocity and altitude during acquisition.

6. The method of claim 1, wherein the imaging platform operates with variable velocity or altitude.

7. The method of claim 1, further comprising classifying complex or partially occluded features as artifacts when their consistency metric deviates from metrics of other features in the scene.

8. The method of claim 1, wherein the method is independent of specific imaging hardware, optical characteristics, or programming language used in the computer vision pipeline.
